(19) United States
(12) Patent Application Publication
(10) Pub. No.: US 2004/0035013 A1
(43) Pub. Date: Feb. 26, 2004

(54) Method and apparatus for transfering measuring points

(76) Inventor: Jessica Ann Cummings, Muncie, IN (US)

Correspondence Address: Clifford W. Browining, Bank One Center/Tower, Suite 3700, 111 Monument Circle, Indianapolis, IN, 46204-5137, US

(21) Appl. No.: 10/607,351

(22) Filed: Jun. 26, 2003

Related U.S. Application Data
(60) Provisional application No. 60/392,268, filed on Jun. 27, 2002.

(51) Int. Cl. G01B 3/00

(52) U.S. Cl. 33/501; 7/164

(57) ABSTRACT

An assembly that can be used to create a measurable point from the top of a three dimensional object to the bottom of a three dimensional object in a three dimensional plane.

The present application claims the benefits of prior-pending U.S. Provisional Patent Application No. 60/392,268, filed Jun. 27, 2002.

### SUMMARY OF THE INVENTION

The assembly of the present application can be used to create a measurable point from the top of a vehicle to the bottom of a vehicle in a three (3) dimensional plane. By setting the assembly indexing marks on both sides of the vehicle at the same point, the measurement at the bottom of the assembly would be the same each time. Using the assembly mentioned above, anyone skilled in the art of measuring could create a location to be measured to on a data sheet or in a computer software program. The following systems that will work with the assembly includes, but is not limited to:

1. Electronic Measuring System of any kind

2. UMS (Universal Measuring System)

3. Tram Bar

4. Centerline Gauges

5. Tape Measure

Attaching the assembly to any given point on a vehicle frame would move said point towards the measuring device, increasing the range of the measuring device.

### DESCRIPTION OF THE DRAWINGS

FIG. 1 is an orthographic side view of the assembly (1000).

FIG. 2 is a third angle orthographic projection of the universal mounting block (100).

FIG. 2a is a third angle orthographic projection of the universal mounting flange (700).

FIG. 3 is a third angle orthographic projection of a typical joint assembly.

FIG. 4 is a third angle orthographic projection of a typical extension arm (300).

FIG. 4a is a third angle orthographic projection of the terminal extension arm showing the threaded hole to which various measuring devices may be attached (655).

FIG. 5 is a perspective view of an alternative embodiment of the assembly (1000).

FIG. 6 is a sectional perspective view of the alternative embodiment of the assembly (1000) of FIG. 5.

### DETAILED DESCRIPTION OF THE PREFERRED EMBODIMENTS

On any vehicle there are flanges, some maybe exposed or one may have to remove trim pieces or remove a weather strip to gain access to the flange. When attaching mounting block (100) push mounting block slot (105) onto a flange. Look for a reference point when attaching mounting block (100) to a vehicle. Use the edge of the mounting block (100) to line up with a seam or joint (where to pieces of metal overlap each other) on the flange. If none are present use tape measure to measure to the nearest reference point you can find, to assure proper mounting of mounting block (100) on both sides of vehicle. Tighten bolts (600) on mounting block (100) to secure mounting block (100) to flange. Mounting block (100) has 5 mounting locations, consisting of 5 different angles for fastening (110) with bolt (625) to mounting block (100). Adjust the indexing marks (200) on (110) to line up with the edges of the angles on mounting block (100) tighten bolt (625) locking (110) to mounting block (100). Fasten extension (300) to (110) by siding extension (300) onto the button (650) which is attached to (110). Rotate the extension (300) until the centerline mark (275) lines up with centerline mark on (110). Tighten bolt (635) to lock extension (300) and (110) together.

Parts (125), (130) and bolt (625) makeup a movable joint that is pre-assembled. User will be able to rotate to any of the indexing marks (200) on (125) & (130). As you line up the indexing marks you will feel the positive locking engagement (680) lining the marks for a correct alignment every time adjustment is made.

Next the user would fasten movable joint (125) & (130) onto extension (300), which has already been, fasten to (110). By siding (300) on to button (650) which is attached to movable joint (125) & (130) using the positive locking mechanism (675). Rotate until the centerline mark (275) on extension (300) lines up with the desired indexing marks (250) on movable joint (125) & (130). Then lock extension to movable joint (125) & (130) with bolt (635).

Now the user can go to the opposite side of vehicle and reverse settings from one side of vehicle to the other side of vehicle, to assure proper measurement on the opposite side of vehicle every time.

Setup continues in the same manner for the rest of the assembly. A user can add as many joints & extensions to the assembly as needed as long as the flange will support the assembly's weight.

Note, the user can adjust the indexing marks (200 & 250) on (110, 125 & 130) to get the desired angles need to clear objects, making it possible for the user to get the assembly to a point below the bottom of the vehicle where it can be measured.

Use thread hole (655) to attach a variety of attachments to the last extension in the assembly, which will allow the user to use one or more of the following measuring devices, but not limited to:

1. Electronic Measuring System of any kind.

2. UMS (Universal Measuring System.

3. Tram Bar.

4. Centerline Gauges.

5. Tape Measure.

Use mounting flange (700) when one needs to add a flange to a vehicle where there is none. Fasten to vehicle using hole (705) and slotted hole (710). Attach mounting block (100) using slot (105) in mounting block (100) to side onto flange (715). Then proceed in the same manner as listed above.

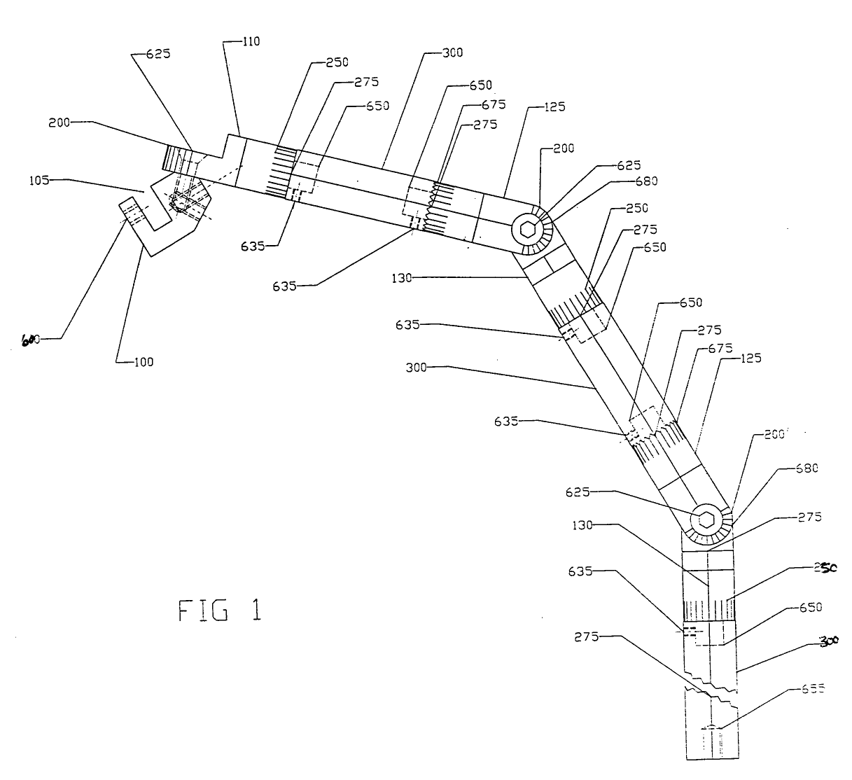

FIG. 1 is an orthographic view of the complete assembly (1000). The preferred embodiment of assembly (1000) is steel and aluminum.

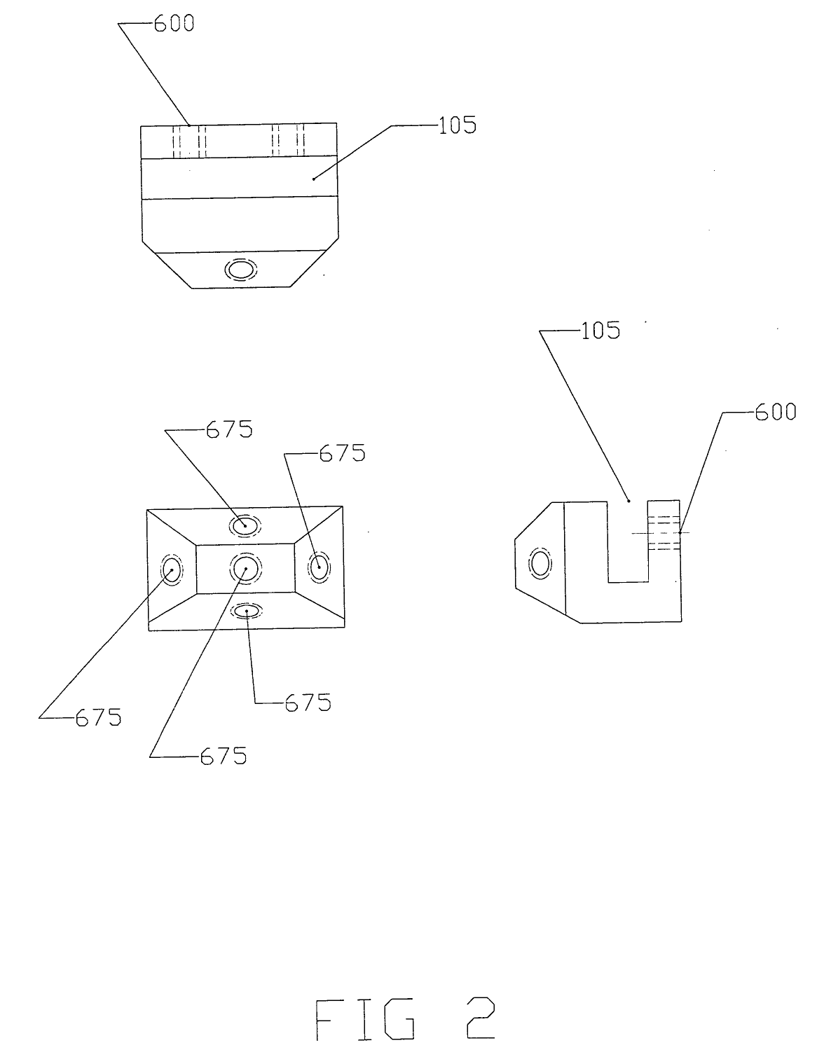

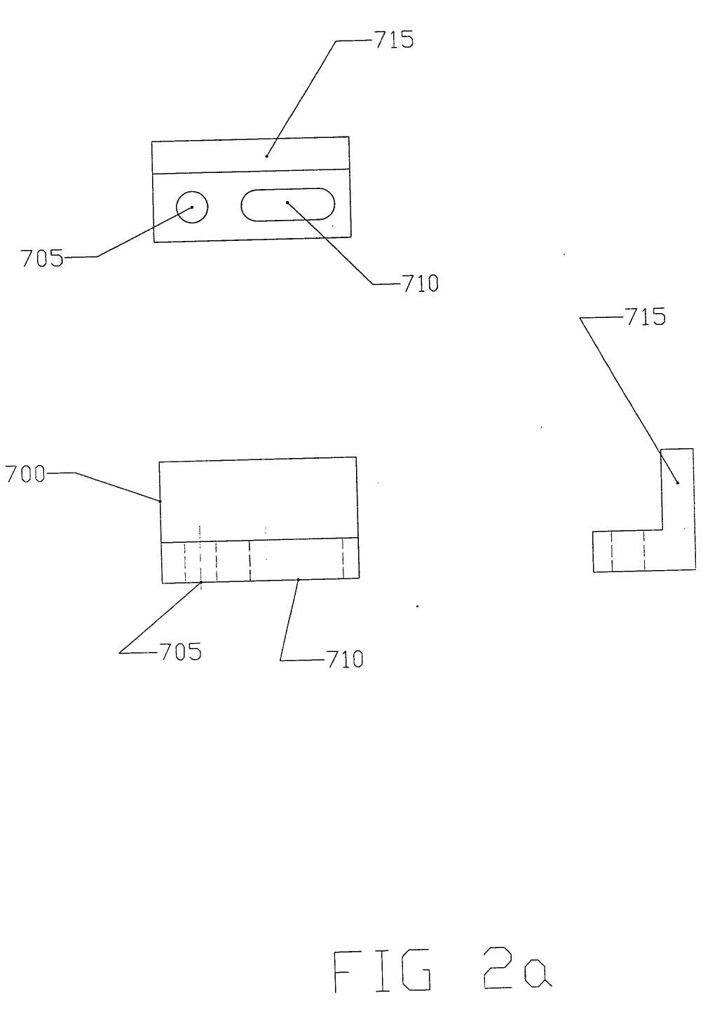

FIG. 2 is a third angle orthographic view of the universal mounting block (100). The preferred embodiment of the universal mounting block is steel. Dividing universal mounting block (100) down the middle long ways, a well-defined notch (105) is place starting at the half point of (100) to facilitate a placement of (100) on the vehicle. Two threaded holes are place in that outer edge closest to the notch (105), to secure placement of (100) on the vehicle. On the opposite side of the mounting block (100) are angles of differencing degrees cut into the surface of mounting block (100) along with 5 threaded holes for (110) to fasten to (100) using bolt (625).

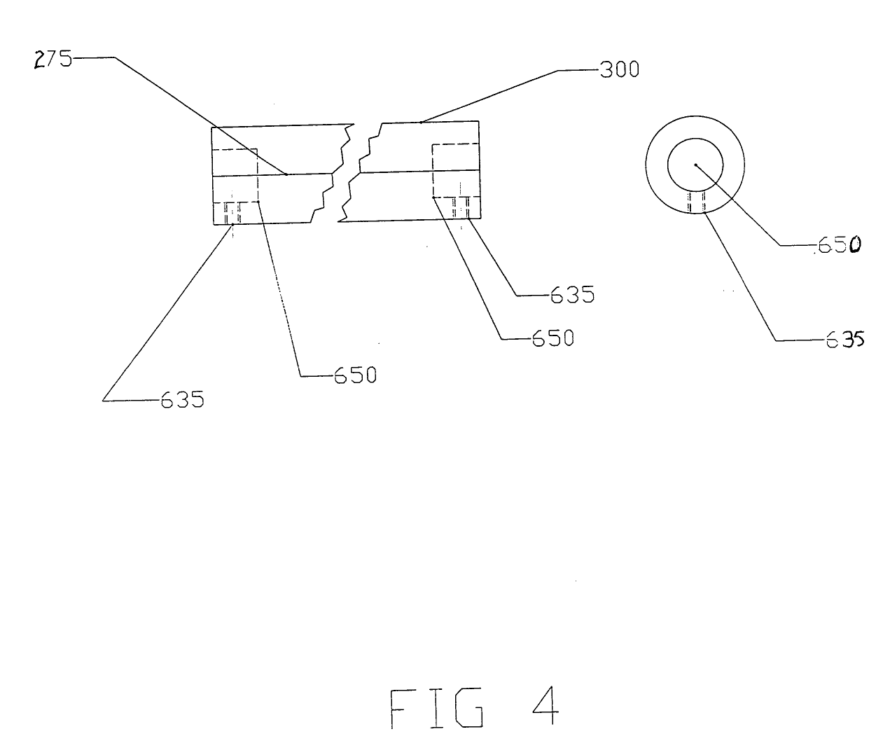

FIG. 2c is a third angle orthographic view it shows (110). The preferred embodiment of (110) is aluminum. (110) Is divided into two half's the top half is machined to half its original thickness and the top half of the width is rounded. Indexing marks (200) are added to the rounded area, so they can be seen looking down on the top of (110). A hole is drill and counter sunk in the top half of (110) allowing it to be bolted to mounting block (100). The bottom half of (110) is turned into a cylinder (rounded) shape. Indexing marks (250) are added to the bottom of (110). A hole is drilled in the bottom center of (110). A button (650) is then inserted into the bottom of (110) with a key way to lock extension (300) in perfect centerline with (110) as seen in FIG. 4. A centerline mark (275) is added the total length of (110).

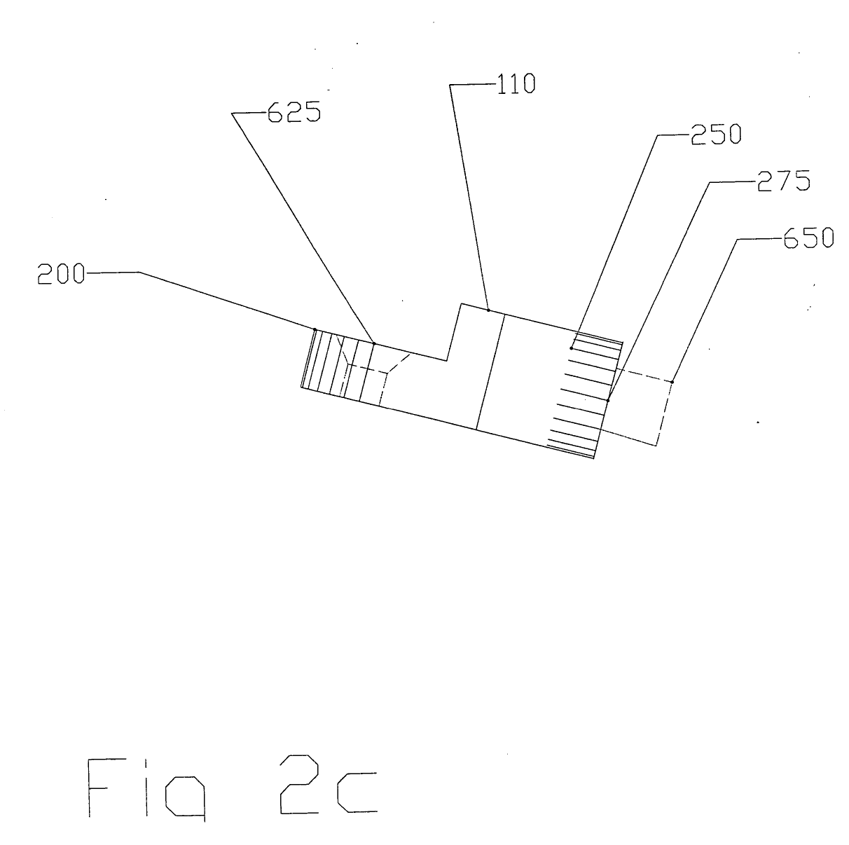

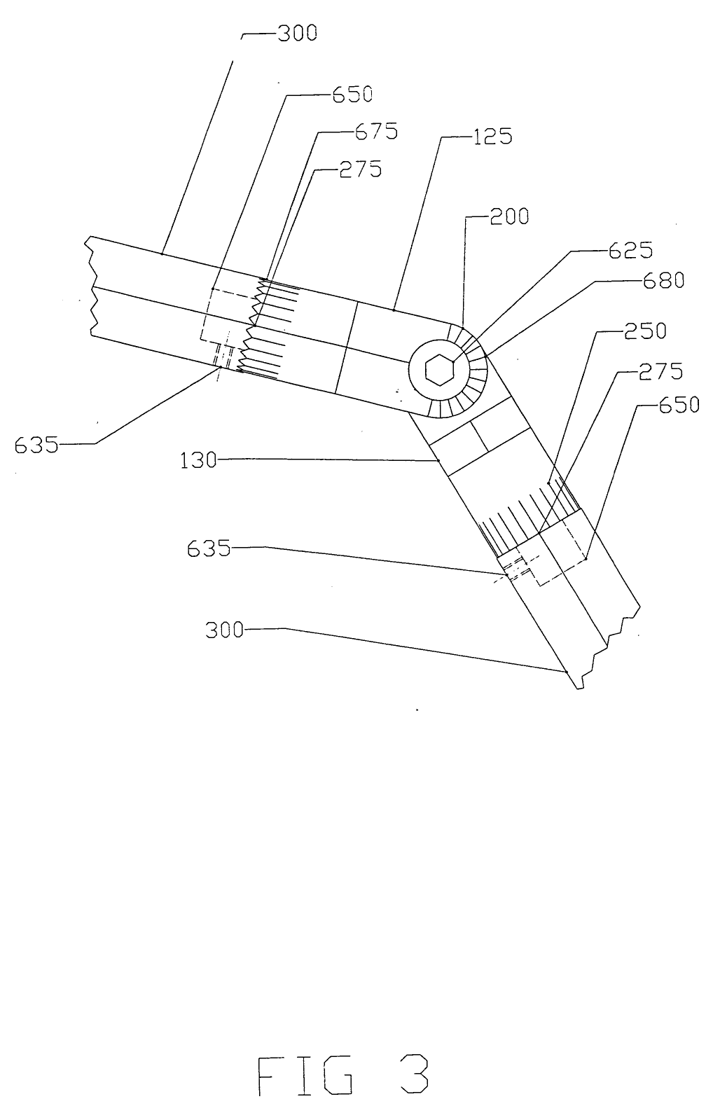

FIG. 4 is a third angle orthographic view. The preferred embodiment of extension (300) is aluminum. Extension (300) has a centerline mark (275) cut into it (300) an internal key slot is cut in extension (300) to line up with either (110) or (130). Extension (300) is sized to fit shaft (650) attached to (110) and (130). 2 Threaded holes with bolts (635) on top and bottom of extension (300) are used to lock extension (300) on to (110), (125) and (130). A positive locking device (675) (as seen in FIG. 3) is added to the bottom of extension (300). Extensions are all made the same way thru out the assembly until you get to the last one in the assembly FIG. 4a.

FIG. 3 is a third angle orthographic view it is a combination of part (125) and (130). The preferred embodiment of the joint (125) and (130) is aluminum and shall be referred to as joint for this example. Joint (125) and (130) is divided into two half's the top half is machined to half its original thickness and the top half of the width is rounded. Indexing marks (200) are added to the rounded area, so they can be seen looking down on the top of (125) and (130). A hole is drill and counter sunk in the top half of (125) allowing it to be bolted to (130). A threaded hole is place in the top half of (130) that allows (125) and (130) to be bolted together. At the same time a positive locking device (680) is added to the mating surface of (125) and (130) to create a positive lock with each other. The bottom half of (125) and (130) is turned into a cylinder (rounded) shape. Indexing marks (250) are added to the bottom of (125) and (130). A hole is drilled in the bottom center of (125) and (130). A button (650) is then inserted into the bottom of (130) with a key way to lock extension (300) in perfect centerline with (130) as seen in FIG. 4. A button (650) is also added to the bottom of (125) along with a positive locking device (675) to mate with the positive locking device on extension (300). A centerline mark (275) is added the total length of (125) and (130).

FIG. 4a is a third angle orthographic view it is the same as FIG. 4 except the bottom the extension has a thread hole (655) to accept numerous measuring devices to be used with this assembly.

FIG. 2a is a third angle orthographic view it is the Universal Flange Mounting (700). The preferred embodiment of (700) is steel. The Universal Flange Mounting (700) is L-shaped at one end of (700) a hole (705) is place and on the other end of (700) a slot (710) is cut.

Note, any Extension added to assembly after last joint (125) and (130) has no positive locking device or key way on either end of the extension. There is no centerline mark that is required after the last joint.

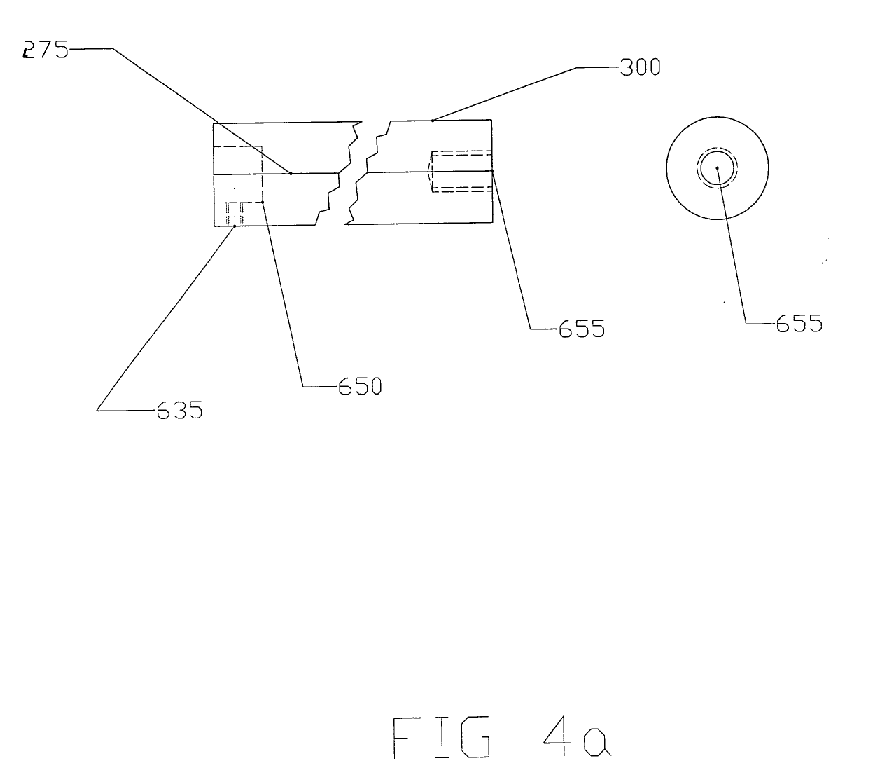

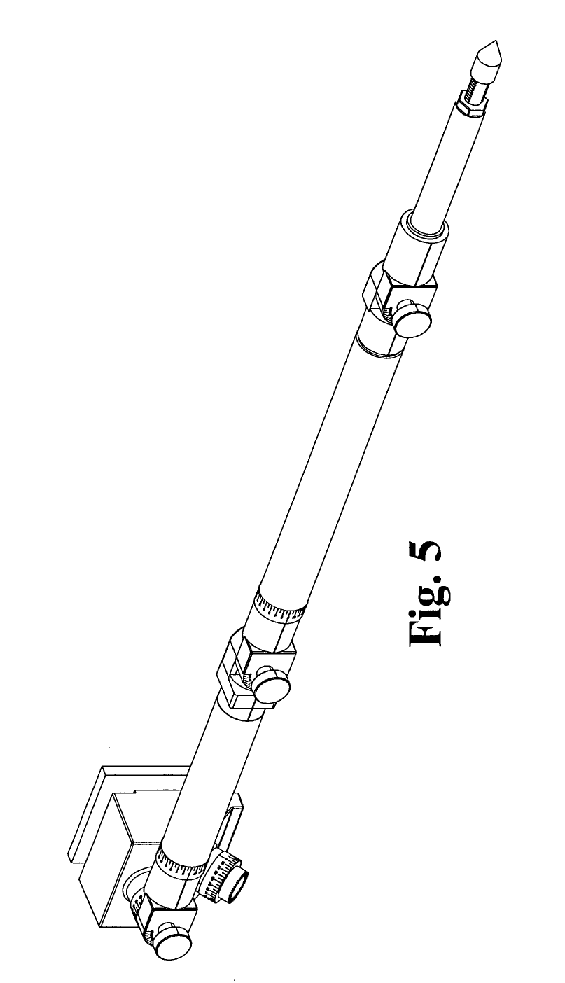

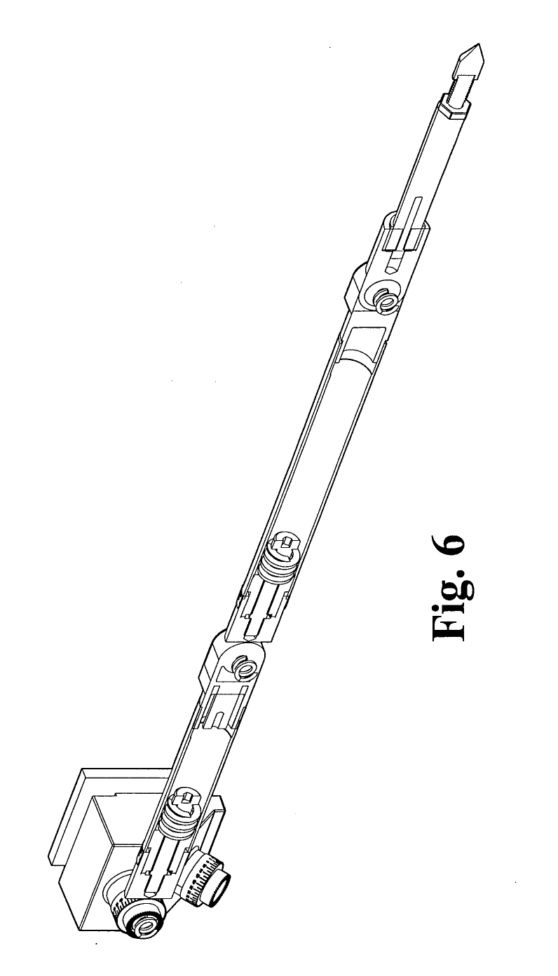

FIGS. 5 and 6 illustrate an equally preferred embodiment of the assembly (1000) of the present invention.

I claim:

1. An apparatus for transferring measuring points, comprising transferring means to create a measurable point from the top of a three dimensional object to the bottom of a three dimensional object in a three dimensional plane.

2. A method for transferring measuring points, comprising providing transferring means to create a measurable point from the top of a three dimensional object to the bottom of a three dimensional object in a three dimensional plane.
